(19) United States
(12) Patent Application Publication
(10) Pub. No.: US 2013/0109004 A1
(43) Pub. Date: May 2, 2013

(54) HUMAN MODEL

(71) Applicants: Christopher T. HARDY, Springfield, IL (US); Jian Hua Xu, Xiao Shan (CN); Keying ZHANG, Hangzhou (CN)

(72) Inventors: Christopher T. HARDY, Springfield, IL (US); Jian Hua Xu, Xiao Shan (CN); Keying ZHANG, Hangzhou (CN)

(73) Assignee: Design Ideas, Ltd., Springfield, IL (US)

(21) Appl. No.: 13/286,866

(22) Filed: Nov. 1, 2011

(51) Int. Cl. G09B 25/00

(52) U.S. Cl. 434/365

(57) ABSTRACT

This invention is directed to model human figures. More particularly, this invention is directed to a model human figure comprising a frame with joints. This invention is also directed to a model human figure comprising a frame and a wire body with joints.

### FIELD OF THE INVENTION

The invention is directed to model human figures. More particularly, the invention is directed to a model human figure comprising a frame and joints. The invention is also directed to a model human figure comprising a frame and a wire body with joints.

### BACKGROUND OF THE INVENTION

Models are widely available in an assortment of shapes, styles, and colors to represent full scale objects and/or living creatures. Human models are often used by artists and art students to draw the human form in a variety of poses. Models may also be used as toys, decorations, desk accessories, and other purposes. Many of the models available today, however, have limitations. For example, many of the available models are not capable of being posed in a standing position without the aid of a pedestal or a support rod. Many models have only limited or unidirectional movement of limbs, limiting the variety of poses they can achieve and reducing the life-likeness of those poses.

Art students often use human models to practice drawing the basic human shape. A commonly used artist model is made of wooden pieces representing human body segments and is held together by an internal wire. Such a model, however, is often unable to stand on its own and therefore must be supported by a rod or the feet must be affixed to a base in order to achieve a standing position. This may prevent the model from achieving a variety of positions, such as a sitting position, and may require the inclusion of a foreign element in the model. The wooden segments are solid and opaque, preventing the artist from seeing the opposite side and from viewing the three-dimensional shape of the model. The wooden models also have simple wooden hands that are incapable of holding items. The wooden models have joints that contain springs, making it difficult for the model to remain in a given pose without springing back to a neutral position.

Thus, there is a need in the art for a model with movable segments, that can stand or be arranged in a variety of positions, including a standing and sitting position, that enables the viewer to see through the model to the opposite side, and that has joints allowing for a four way range of motion and enabling the model to stay in a posed position.

### BRIEF SUMMARY OF THE INVENTION

The invention relates to human models with an internal frame and joints to enable movement. The invention also relates to human models with an internal frame, a wire external frame, and joints to enable movement. The model may also include hands capable of holding objects.

### BRIEF DESCRIPTION OF THE DRAWINGS

In the accompanying drawings that form a part of the specification and are to be read in conjunction therewith, the present invention is illustrated by way of example and not limitation, with like reference numerals referring to like elements, wherein:

FIG. 1 illustrates a first example of a model of the present invention.

FIGS. 2A and 2B illustrate second examples of a model of the present invention.

FIG. 3 illustrates an example of the external frame of the model of FIG. 2A.

FIG. 4A illustrates an example of a joint of the present invention.

FIG. 4B illustrates an exploded view of the joint of FIG. 4A.

FIGS. 5A-5D illustrate the movement of the joint of FIG. 4.

FIGS. 6A-6G illustrates the model of FIGS. 1 and 2A in a variety of poses.

### DETAILED DESCRIPTION OF THE INVENTION

The invention relates to a human model with an internal frame and joints that allow the model to be posed in a variety of life-like positions including an unaided standing position. The model may also contain a wire external frame. The model may also contain hands capable of holding objects.

As used herein, the terms below are given the definitions that follow. The definitions are supplied to provide clarity and consistency and are not intended in any way to limit the scope of the invention.

Model or Human Model: an inanimate object used to represent the human form.

Internal Frame: a structural portion of a model that provides support for the model.

External Frame, External Wire Frame, or Wire Frame: a portion of a model made of wire that represents the outside of a body and is supported by the internal frame.

Joint: a mechanism which joins together two body segments.

Square Bracket: a material formed in a generally square shape serving as the support for the hinges in a joint.

The model of the present invention includes an internal frame and several joints that mimic human joints. A wire external frame may be disposed around internal frame. Model is capable of standing on its own as well as being posed in a variety of other configurations such as sitting, kneeling, lying down, etc. Model may also contain hands capable of holding objects.

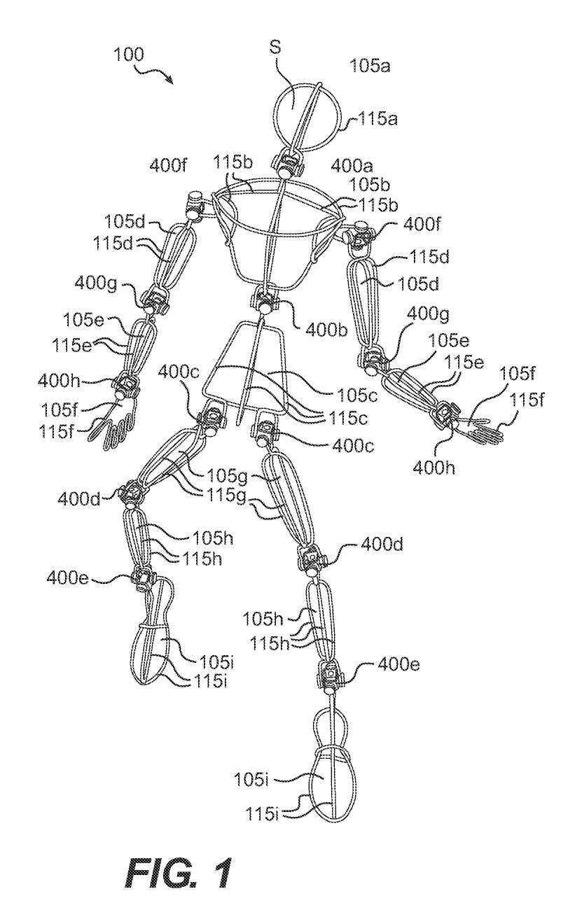

FIG. 1 illustrates an example of a first model 100 of the present invention. FIG. 1 illustrates a front view of model 100. First model 100 can be any size provided the proportions are recognizable as human.

First model 100 generally comprises several body segments 105 representing human body segments. For example, first model 100 includes one head segment 105a, one chest segment 105b, one pelvis segment 105c, two upper arm segments 105d, two forearm segments 105e, two hand segments 105f, two upper leg segments 105g, two lower leg segments 105h, and two foot segments 105i.

As shown in FIG. 1, first model 100 includes an internal frame 115. Internal frame 115 provides structure to first model 100. Internal frame 115 is divided into several internal frame body segments 115a-115i that correspond to each of the body segments 105a-105i. For example, head segment 105a contains an internal frame head segment 115a; chest segment 105b contains an internal frame chest segment 115b; pelvis segment 105c contains an internal frame pelvis segment 115c; each upper arm segment 105d contains an internal frame upper arm segment 115d; each forearm segment 105e contains an internal frame forearm segment 115e; each hand segment 105f contains an internal frame hand segment 115f; each upper leg segment 105g contains an internal frame upper leg segment 115g; each lower leg segment 105h contains an internal frame lower leg segment 115f; and each foot segment 105i contains an internal frame foot segment 115i.

Each internal frame body segment 115 is a support structure that acts as a “skeleton” and provides first model 100 with its basic shape. Unlike an actual human skeleton, however, internal frame 115 is not made of single bones in the center of the body part it is supporting. Instead, each internal frame segment 115 is molded in the general shape of the body part is it representing. For example, as can be seen in FIG. 1, internal frame foot segment 115i is molded in the general shape of a foot. Likewise, internal frame forearm segments 115e are molded in the general shape of forearms and internal frame head segment 115a is molded in the general shape of a head.

Internal frame foot segment 115i is configured so that the bottom of foot segment 105i is flat, enabling model 100 to stand on a flat surface with no additional support. Internal frame hand segment 115f may be molded to include the shape of fingers to enable hand segment 115f to hold small objects, such as paper, stamps, business cards, greeting cards, brochures, or any other suitable object.

Internal frame 115 can be made of any material capable of supporting model 100. By way of example, internal frame 115 can be made of metal (such as, for example, stainless steel, iron, copper, aluminum, epoxy coated steel, vinyl coated steel, steel with an anodized finish), plastic, or any other suitable material. Internal frame 115 can retain the color of the underlying material or it can be changed to another color by painting, dying, coating, or any other means capable of changing the color.

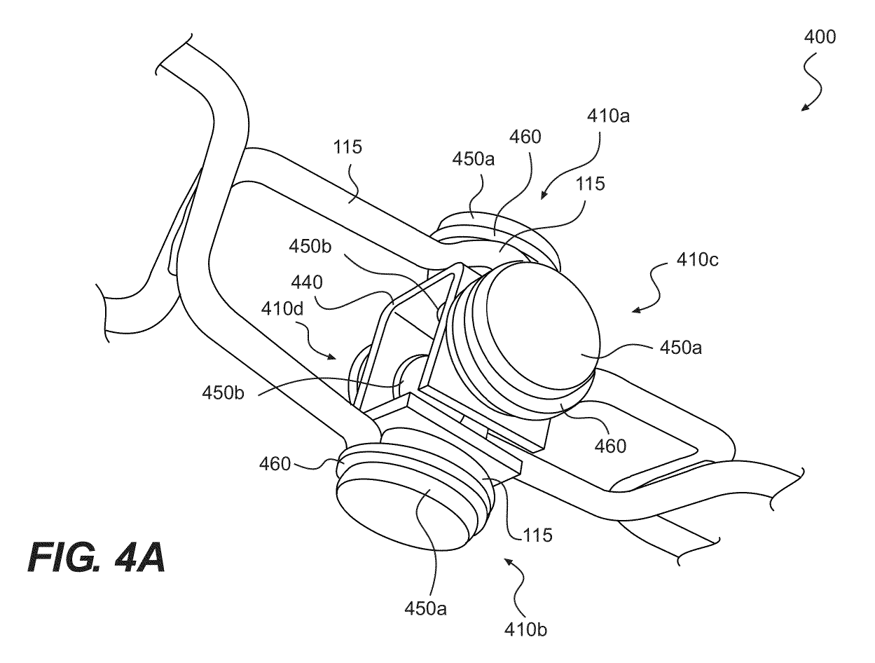

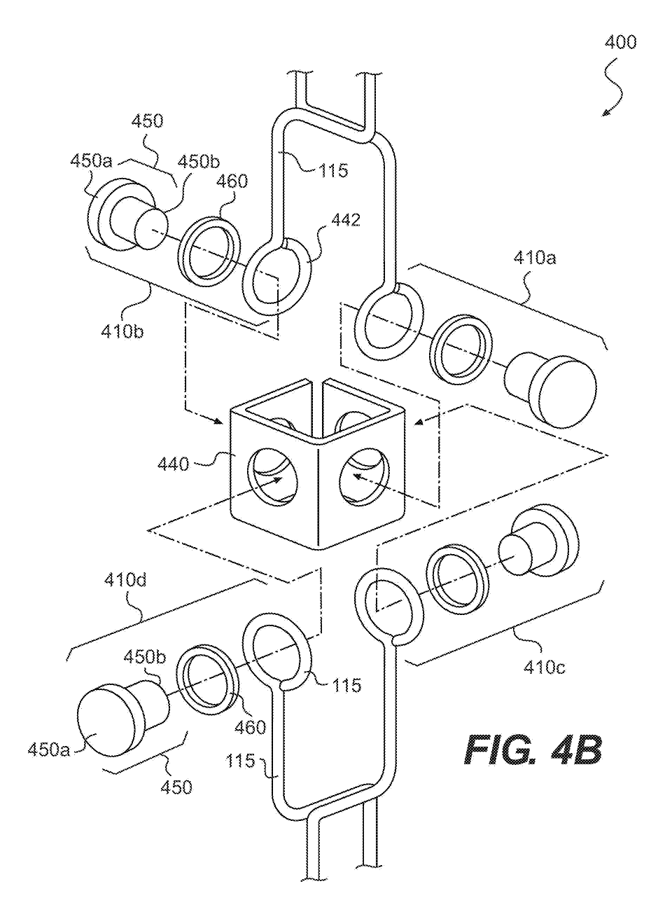

Body segments 105 are connected by joints 400 (which are shown in more detail in FIG. 4), including one neck joint 400a, one waist joint 400b, two hip joints 400c, two knee joints 400d, two ankle joints 400e, two shoulder joints 400f, two elbow joints 400g and two wrist joints 400h.

Specifically, neck joint 400a connects internal frame head segment 115a with internal frame chest segment 115b; waist joint 400b connects internal frame chest segment 115b with internal frame pelvis segment 115c; each hip joint 400c connects internal frame pelvis segment 115c with an internal frame upper leg segment 115d; each knee joint 400d connects an internal frame upper leg segment 115d with the corresponding internal frame lower leg segment 105e; each ankle joint 400e connects an internal frame lower leg segment 115e with a corresponding internal frame foot segment 115f; each shoulder joint 400f connects internal frame chest segment 115b with an internal frame upper arm segment 115g; each elbow joint 400g connects an internal frame upper arm segment 115g with a corresponding internal frame forearm segment 115h; and each wrist joint 400h connects an internal frame forearm segment 115h with the corresponding internal frame hand segment 115i. Joints 400 correspond to analogous human joints except that the “waist joint” 400b is a single joint that replaces the movement allowed by the vertebra in a living human.

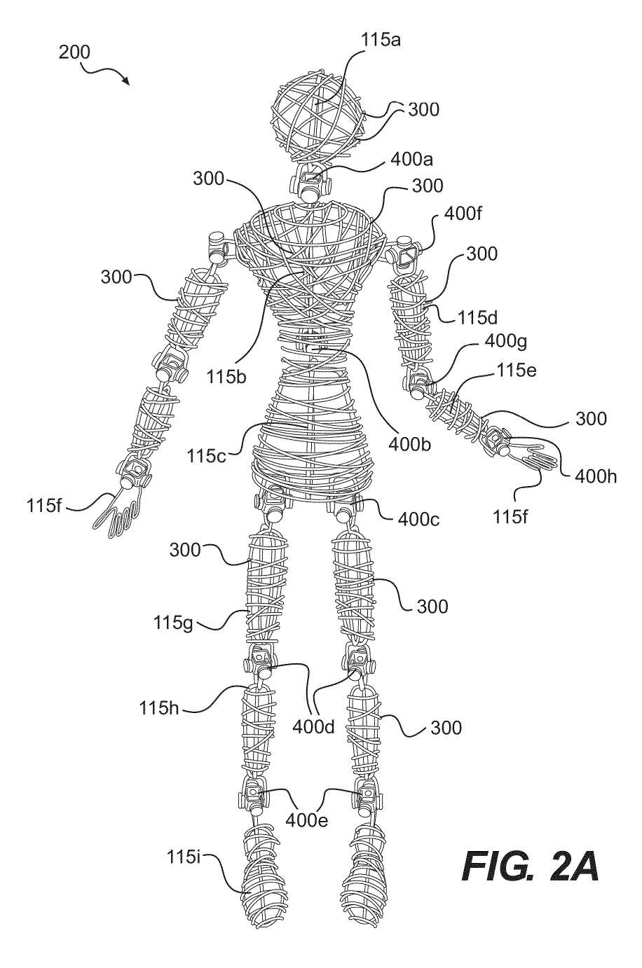

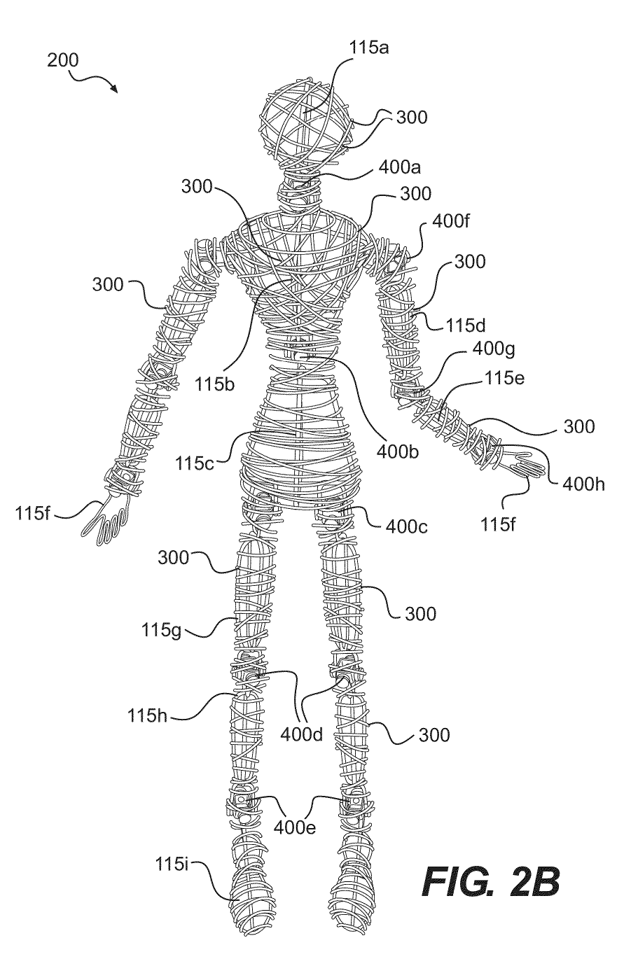

FIGS. 2A and 2B illustrate examples of a second model 200 of the present invention. Second model 200 can be any size provided the proportions are recognizable as human.

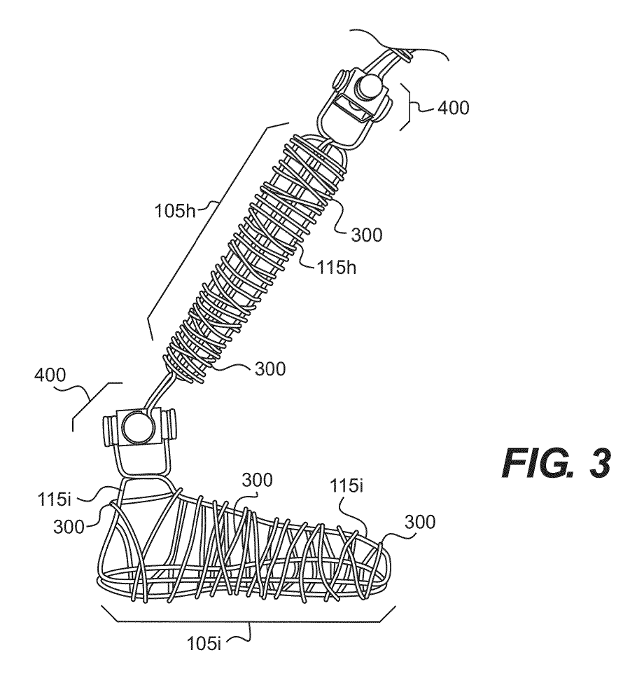

Second model 200 includes all of the elements of first model 100 and an external wire frame 300 (shown in more detail in FIG. 3).

In second model 200, each body segment 105 is made from a corresponding internal frame body segment 115 and may be surrounded by wire of the external frame 300. For example, head segment 105a contains an internal frame head segment 115a surrounded by wire 300; chest segment 105b contains an internal frame chest segment 115b surrounded by wire 300, pelvis segment 105c contains an internal frame pelvis segment 115c surrounded by wire 300, each upper arm segment 105d contains an internal frame upper arm segment 115d surrounded by wire 300, each forearm segment 105e contains an internal frame forearm segment 115e surrounded by wire 300, each hand segment 105f contains an internal frame hand segment 115f, each upper leg segment 105g contains an internal frame upper leg segment 115g surrounded by wire 300; each lower leg segment 105h contains an internal frame lower leg segment 115f surrounded by wire 300; and each foot segment 105i contains an internal frame foot segment 115i surrounded by wire 300.

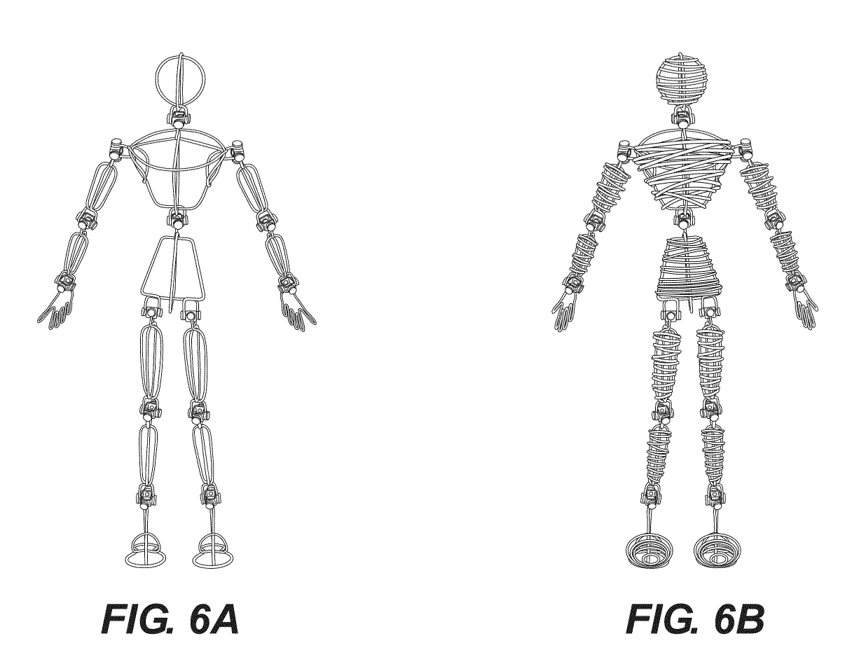

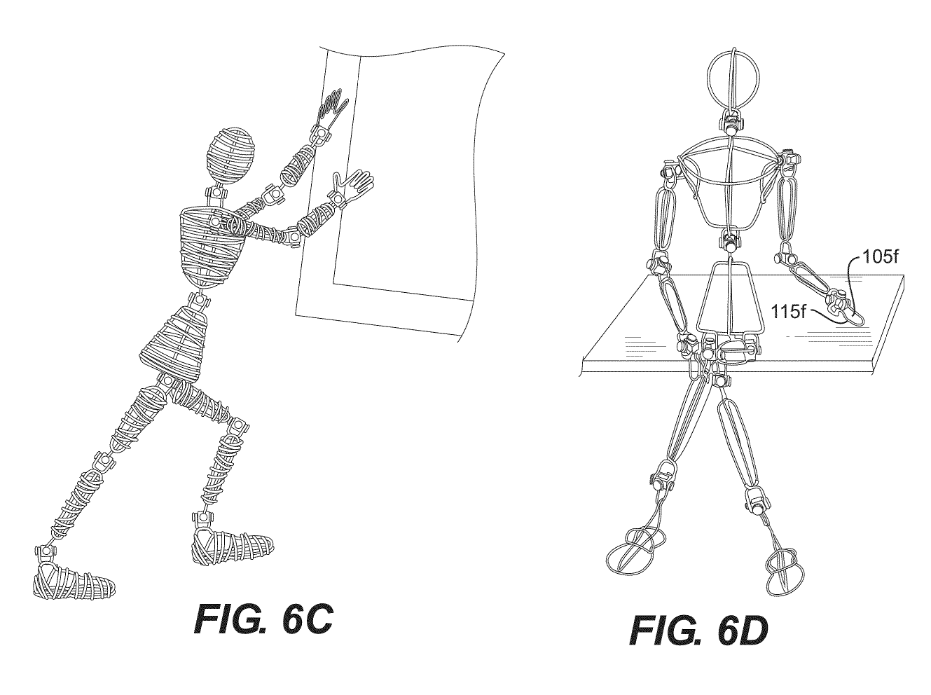

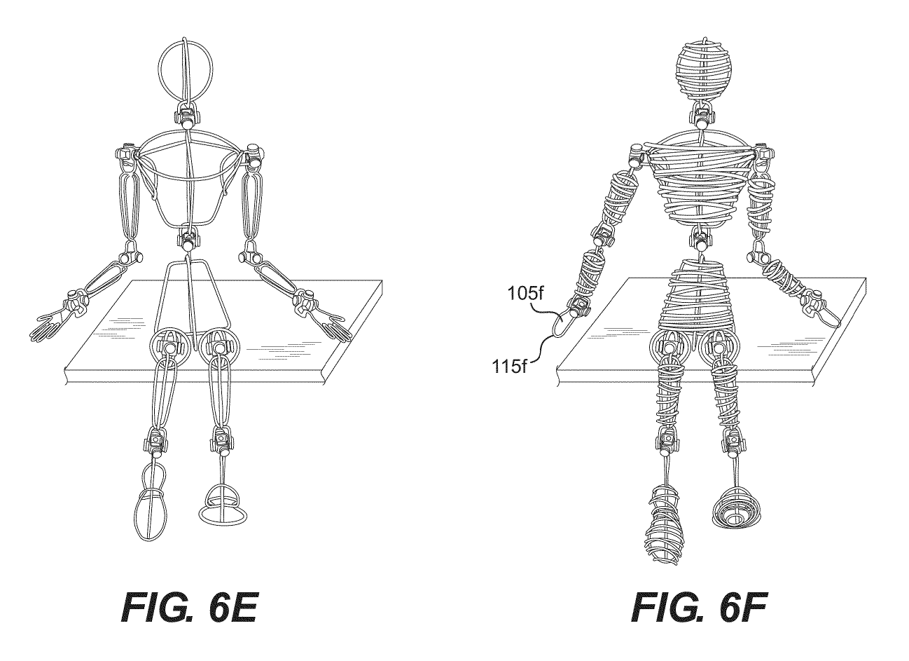

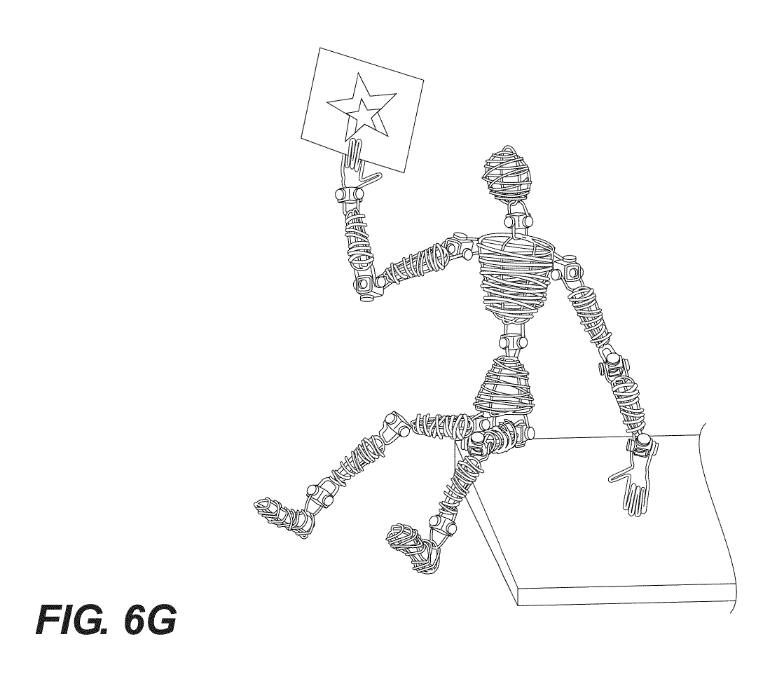

External wire 300 is wrapped around internal frame foot segments 115i in such a manner that the bottom of the foot segments 105i remain flat, enabling model 200 to stand on a flat surface with no additional support. As shown in FIG. 2A and 2B, Internal frame hand segments 115f may remain free of external wire 300 to allow the “fingers” to hold small objects (see FIG. 6G). In other embodiments (not shown) internal frame hand segments 115f may also be wrapped in wire 300.

As shown in FIG. 2A, external wire 300 may be wrapped around internal body segments 115 but not wrapped around joints 400. As shown in FIG. 2B, external wire 300 may be wrapped around both internal body segments 115 and joints 400.

FIG. 3 illustrates a portion of second model 200 from FIG. 2A showing external frame 300. External frame 300 is comprised of wire wrapped around internal frame 115. The wire of external frame 300 can be made of any material capable of wrapping around internal frame 200. By way of example, the wire can be made of metal (such as, for example, stainless steel, iron, copper, aluminum, epoxy coated steel, vinyl coated wire), plastic, or any other suitable material. The wire can retain the color of the underlying material or it can be changed to another color by painting, dying, coating, or any other means capable of changing the color.

External frame 300 is wrapped around each internal frame body segment 115 in such a way that it provides a general appearance of the corresponding body part of a human being. For example, as shown in FIG. 3, external frame 300 is wrapped around internal frame lower leg segment 115h in such a way that the resulting lower leg segment 105h generally resembles the lower leg shape of a human being. Similarly, external frame 300 is wrapped around internal frame foot segment 115i in such a way that the resulting foot segment 105i generally resembles the foot shape of a human being.

External frame 300 can be wrapped around internal frame 115 by any means capable of disposing external frame 300 around internal frame 115. By way of example, external frame 300 can be wrapped around internal frame 115 by hand or by machine or by a combination of the two.

External frame 300 may be comprised of any number of wires. For example, external frame 300 may be one continuous wire that is wrapped around all of internal frame body segments 115. External frame 300 may include several wires, each of which is wrapped around a separate internal frame body segment 115. External frame 300 may also be several wires and more than one wire may be wrapped around each internal frame body segment 115. Any number of wires can be wrapped around any number of internal frame body segments 115.

FIG. 4A illustrates one example of a joint 400 of the present invention. FIG. 4B illustrates an exploded view of joint 400 of FIG. 4A. Joint 400 is comprised of four hinges 410, namely a first hinge 410a, a second hinge 410b, a third hinge 410c, and a fourth hinge 410d. First hinge 410a and second hinge 410b together make up the first hinge pair. Third hinge 410c and fourth hinge 410d together make up the second hinge pair. Hinges 410 are arranged around a square bracket 440. First hinge 410a is located across from second hinge 410b on square bracket 440. Third hinge 410c is located at a 90 degree angle from first hinge 410a and second hinge 410b and across from fourth hinge 410d on square bracket 440. Fourth hinge 410d is located at a 90 degree angle from first hinge 410a and second hinge 410b and across from third hinge 410c on square bracket 440.

In the example shown in FIGS. 4A and 4B, each hinge 410 is made from a rivet 450 installed on square bracket 440 over a portion of internal frame 115. This configuration allows movement of internal frame 115 around rivet 450 and secures internal frame 115 to rivet 450, thereby attaching joints 400 to model 100 and 200 (see FIGS. 1, 2A and 2B). Square bracket 440 may be made of any material suitable for holding rivets 450. By way of example, square bracket 440 may be made of metal (such as, for example, stainless steel, iron, copper, aluminum, epoxy coated steel, vinyl coated steel, steel with an anodized finish), plastic or any other material capable of holding rivets 450. Rivet 450 may be made of any material suitable for installation on square bracket 440. By way of example, rivet 450 may be metal (such as, for example, aluminum, stainless steel, iron, copper, aluminum, epoxy coated steel, vinyl coated steel, steel with an anodized finish), plastic (such as, for example, polyprolylene and ABS), or any other suitable material. The factory head 450a of rivet 450 is positioned on the outside of internal frame 200 and the shop head 450b of rivet 450 is positioned on the inside of square bracket 440. In one example, a spacer 460 is located between factory head 450a of rivet and internal frame 115. Spacer 460 provides a cushion between factory head 450a of rivet and internal frame 115 and assists in maintaining resistance between internal frame 115 and joint 400, enhancing the ability of body segments 105 to maintain poses. Spacer 460 can be made of any material capable of cushioning joint 400. By way of example, spacer 460 may be made of metal (such as, for example, stainless steel, iron, copper, aluminum, epoxy coated steel, vinyl coated steel, steel with an anodized finish), plastic (such as, for example, acetate or polyvinyl chloride) or any other suitable material. This particular assembly is for illustration purposes only and is not intended to limit the scope of the invention.

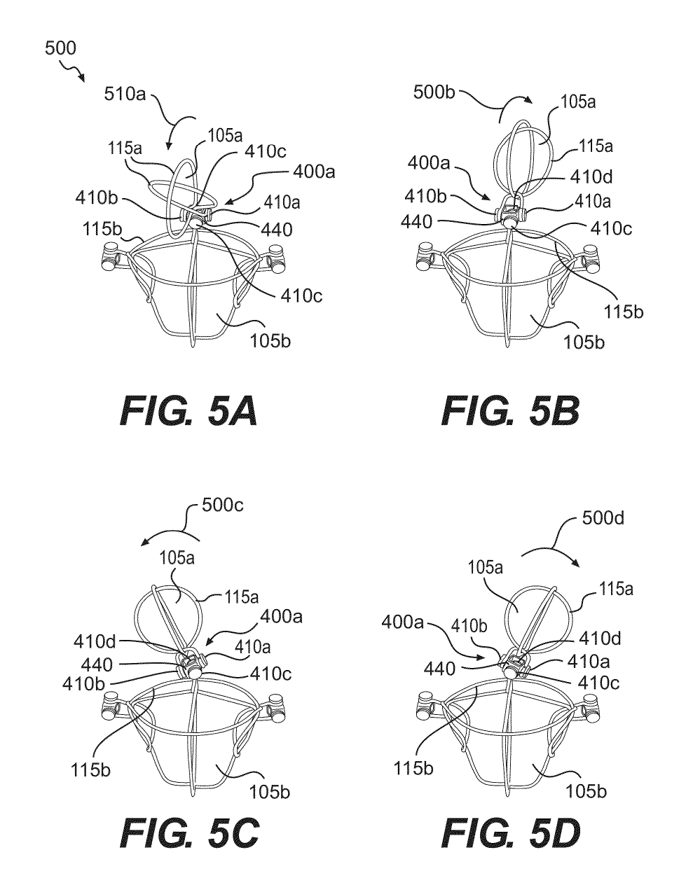

FIGS. 5A-5D illustrate the movement 500 of joint 400 in four directions along two axes. Specifically, FIGS. 5A-5D illustrate the movement of internal frame head segment 115a relative to internal frame chest segment 115b via the movement of neck joint 400a. Neck joint 400a is representative of all of the joints 400 in the models 100 and 200 (see FIGS. 1, 2A and 2B) and is shown to illustrate how each of the joints 400 function.

FIG. 5A illustrates the movement of internal frame head segment 115a in a forward direction 500a along a first axis. To move in forward direction 500a, first hinge pair (comprising first hinge 410a and second hinge 410b) rotate forward while square bracket 440 and second hinge pair (comprising third hinge 410c and fourth hinge 410d) remain stationary.

FIG. 5B illustrates the movement of internal frame head segment 115a in a backward direction 500b along first axis. To move in backward direction 500b, first hinge pair (comprising first hinge 410a and second hinge 410b) rotate backward while square bracket 440 and second hinge pair (comprising third hinge 410c and fourth hinge 410d) remain stationary.

FIG. 5C illustrates the movement of internal frame head segment 115a in a right side direction 500c along second axis. To move in right side direction 500c, second hinge pair (comprising third hinge 410c and fourth hinge 410d) rotate to the right while square bracket 440 and first hinge pair (comprising first hinge 410a and second hinge 410b) remain stationary.

FIG. 5D illustrates the movement of internal frame head segment 115a in a left side direction 500d along second axis. To move in left side direction 500d, second hinge pair (comprising third hinge 410c and fourth hinge 410d) rotate to the left while square bracket 440 and first hinge pair (comprising first hinge 410a and second hinge 410b) remain stationary.

Thus, neck joint 410a (and the other joints 400, not shown) are each capable of moving in four directions—front 500a, back 400b, right side 400c, and left side 400d—along two axes (a front-back axis and a right-left axis). Each hinge pair is capable of moving along one axis—the first hinge pair (comprising first hinge 410a and second hinge 410b) is capable of moving along the first axis (the front-back axis) and the second hinge pair (comprising third hinge 410c and fourth hinge 410d) is capable of moving along the second axis (the right-left axis). The front-back direction of the first axis is 90 degrees from the right-left direction of the second axis.

Such range of movement allows each body segment 105 to be positioned in numerous positions, enabling the models 100 and 200 (see FIGS. 1, 2A and 2B) to be configured in a variety of human like poses (see FIGS. 6A-6G).

FIGS. 6A-6G illustrate models 100 and 200 in a variety of poses. FIG. 6A illustrates model 100 in an unaided standing position. FIG. 6B illustrates model 200 in unaided standing position. FIG. 6C illustrates model 200 in a leaning position. In FIG. 6C, model 200 is leaning against a computer monitor. FIG. 6D illustrates model 100 in a sitting position with crossed legs. In this illustration, the internal frame hand segments 115f of hand segments 105f are not formed into fingers, and are instead formed into a more general mitten shape. FIG. 6E illustrates model 100 in a sitting position with legs uncrossed. FIG. 6F illustrates model 200 in a sitting position with legs uncrossed. In this illustration, internal frame hand segments 115f of hand segments 105f are not formed into fingers, and are instead formed into a more general mitten shape. FIG. 6G illustrates model 200 in a reclined sitting position holding a paper object.

1-11. (canceled)

12. A model comprising:
an internal frame including internal frame body segments representing the structure of human body parts;
an external frame, comprising wire, wherein said wire is disposed around said internal frame, and
joints that couple said internal frame body segments and allow movement of thereof along two axes.

13. The model of claim 12, wherein said body segments define a central open space.

14. The model of claim 12, wherein said body segments include a chest body segment and a separate pelvis body segment movably coupled by one of said joints.

15. The model of claim 12, further including body segments forming feet including a flat bottom.

16. The model of claim 12, further including body segments forming hand segments, said hand segments each including fingers capable of holding an object.

17. The model of claim 12, wherein said joints further include a bracket.

18. The model of claim 1₇, wherein said body segments further include a first body segment and a second body segment, said first body segment including a first connection portion, said second body segment including a second connection portion, where said first and second connection portions are movably coupled to said bracket.

19. The model of claim i8, wherein said joints further include a first hinge pair movably coupling said first body segment to said bracket, and a second hinge pair movably coupling said second body segment to said bracket, wherein said first hinge pair is positioned approximately ₉0 degrees from said second hinge pair.

20. The model of claim 1₉, wherein said joints further include first and second pairs of spacers, said first pair of spacers being located between said first hinge pair and said first body segment, and second pair of spacers being located between said second hinge pair and said second body segment, wherein said first and second pairs of spacers provide resistance to movement of said first and second body segments such that said model is able to assume a plurality of positions including an unaided standing position.

21. the model of claim 20, wherein said hinges are rivets.

22. The model of claim 20, wherein said spacers are selected from a group including metal, spring metal, plastic, acetate, or stainless steel.

23. The model of claim i6, wherein said fingers are free of said external frame.

24. The model of claim 12, wherein said internal frame body segments include an internal frame head segment, an internal frame chest segment, an internal frame pelvis segment, internal frame upper arm segments, internal frame forearm segments, internal frame hand segments, internal frame upper leg segments, internal frame lower leg segments, and internal frame feet segments.

25. The model of claim 12, wherein said model is capable of remaining in a standing position.

26. The model of claim 12, wherein said model is capable of remaining in a sitting position.

27. The model of claim 12, wherein said wire is wrapped around the outside of one or more of said internal frame body segments.

28. A model comprising:
an internal frame including body segments representing the structure of human body parts, said body segments being formed of wire and including hand body segments including fingers capable of holding objects;
an external frame, comprising wire, wherein said wire is disposed around said body segments, and joints that couple said body segments and allow movement of thereof along at least two axes, each of said joints further including:
a bracket,
a first hinge pair movably coupling one of said body segments to said bracket,
a second hinge pair movably coupling another of said body segments to said bracket, and
first and second pairs of spacers, said first pair of spacers being located between said first hinge pair and its associated body segment, and second pair of spacers being located between said second hinge pair and its associated body segment, wherein said first and second pairs of spacers provide resistance to movement of said associated body segments such that said model is able to maintain poses including an unaided standing position.

29. The model of claim 28, wherein said body segments define a central open space.
